(19) United States
(12) Patent Application Publication
(10) Pub. No.: US 2016/0308829 A1
(43) Pub. Date: Oct. 20, 2016

(54) INFORMATION SECURITY DEVICE AND INFORMATION SECURITY METHOD THEREOF

(71) Applicant: ELECTRONICS AND TELECOMMUNICATIONS RESEARCH INSTITUTE, Daejeon (KR)

(72) Inventor: Jong Tae SONG, Daejeon (KR)

(21) Appl. No.: 15/098,520

(22) Filed: Apr. 14, 2016

(30) Foreign Application Priority Data
Apr. 15, 2015 (KR) 10-2015-0053005

(51) Int. Cl. H04L 29/06; G06F 21/50

(52) U.S. Cl. CPC H04L 63/0209; G06F 21/50

(57) ABSTRACT

An information security device that inspects information being transmitted between a server that provides a social network service (SNS) and a terminal and that allows transmission of information selectively based on a predetermined security condition; a terminal that exchanges information with the server through the information security device; and a network system including the same, so as to provide an effect of preventing confidential information from being leaked outside through the social network service while providing the social network service through the terminal of an internal network.

### CROSS-REFERENCE TO RELATED APPLICATION

The present application claims priority to Korean patent application number 10-2015-0053005, filed on Apr. 15, 2015, the entire disclosure of which is incorporated herein in its entirety by reference.

### BACKGROUND

1. Field of Invention

Various embodiments of the present disclosure relate to an information security device and an information security method thereof, and more particularly, to an information security device configured to selectively transmit or block information, and an information security method thereof.

2. Description of Related Art

A next generation firewall is a firewall that analyzes a payload of a packet to determine the actual type of application in order to allow only permitted applications to pass between an internal network and external network. There are numerous ways the next generation firewall controls access to an internal network based on application: a method of determining an application that is permitted to the entire internal network, and a method of determining an application permitted for each user.

With the expansion of social network services (hereinafter referred to as SNS), there are cases where an SNS is used in an internal network. For example, an internal network user may search information or post information through an SNS. Therefore, a next generation firewall passes the necessary SNS traffic according to the internal network user so that information exchange can be made with an external network.

In such cases, confidential information of the internal network may leak through the SNS which is a problem. Moreover, since an SNS exposes information to multiple users, should confidential information leak, the damages will be great, which is a problem.

Furthermore, when a service access is initiated in an SNS, information is exchanged after an encrypted connection is made between a terminal and the SNS server. However, since SNSs may have different kinds of encrypting techniques, and since encrypting method often changes, it is difficult to track which information is being exchanged through an encrypted SNS. Therefore, there occurs a problem that when confidential information leaks through an SNS, it is difficult to track the user who leaked the information, and it is difficult to prevent a virus from entering and contaminating the internal network through the SNS.

### SUMMARY

Various embodiments of the present disclosure are directed to provide an information security device configured to selectively allow or block information exchange between an SNS server and a terminal, and an information security method thereof, and a terminal configured to be connected to the SNS server through the information security device, and a network system including the same.

Another purpose of the present disclosure is to provide an information security device configured to selectively allow or block information exchange between an SNS and a terminal and to exchange encrypted information with the terminal, a terminal configured to be connected to a server of the SNS through the information security device but that exchanges encrypted information with the information security device, and a network system including the information security device and the terminal.

According to an embodiment of the present disclosure, there is provided an information security device including an SNS relay module configured to receive information from any one of a server that provides a social network service (hereinafter SNS) and a terminal, and determine whether or not the information needs security testing based on a predetermined testing condition; a monitoring module configured to determine whether or not information, that is determined as information that needs security testing, needs security based on a predetermined security condition; and an SNS agent module configured to transmit information determined as information that does not need security testing or information determined as information that does not need security outside.

The predetermined testing condition may include a condition of determining whether or not the information needs security testing based on a type of the information.

The predetermined testing condition may include a condition of determining that the information needs security testing when the type of the information is an image file, a document file, a text, an execution file or a hyperlink.

The predetermined testing condition may include a condition of determining that the information does not need security testing when the type of the information is a type of information related to input or output information of the terminal.

The predetermined security condition may include a condition of determining that the information needs security testing when the content of the information includes a predetermined text.

The predetermined security condition comprises a condition of determining whether or not the information needs security based on a content of the information.

The predetermined security condition comprises a condition of determining that the information needs security when the content of the information comprises a predetermined text.

The monitoring module may delete the information when the content of the information includes the predetermined text.

The device may further include a memory for storing information to be used in track analysis of packets transmitted between the server and the terminal when the content of the information includes the predetermined text.

The monitoring module determines, when the information is a file or a message including hyperlink, whether or not a website corresponding to the hyperlink is a malicious site, and deletes the file or the message based on the determination.

The monitoring module determines, when the information is a file or a message including hyperlink, whether or not a website corresponding to the hyperlink is a malicious site, and performs track analysis of the website.

The device may further include an encrypting/decrypting module configured to decrypt the information being received from any one of the server and the terminal, and to encrypt the information being transmitted outside.

The SNS relay module is configured to receive the information from the SNS agent that is provided in the terminal and allows the SNS to be provided to the terminal through the information security device.

According to another embodiment of the present disclosure, there is provided an information security method, the method including determining, when information is received from any one of a server that provides a social network service (hereinafter SNS) and a terminal, whether or not the information needs security testing based on a predetermined testing condition; determining whether or not information, that is determined as information that needs security testing, needs security based on a predetermined security condition; and transmitting information determined as information that does not need security testing or information determined as information that does not need security to outside.

The predetermined testing condition may include a condition of determining that the information needs security testing when the type of the information is an image file, a document file, a text, an execution file or a hyperlink.

The predetermined testing condition may include a condition of determining that the information does not need security testing when the type of the information is a type of information related to input or output information of the terminal.

The predetermined security condition may include a condition of determining that the information needs security when the content of the information includes a predetermined text.

The method may further include deleting the information when the content of the information includes the predetermined text.

The method may further include storing the information when the content of the information comprises the predetermined text so that the information can be used in track analysis of packets transmitted between the server and the terminal.

The method may further include receiving the information from any one of the server and the terminal; and decrypting the information.

The transmitting the information determined as information that does not need security testing or that does not need security to outside may include encrypting the information being transmitted outside.

According to an embodiment of the present disclosure, since a social network service (SNS) may be used adequately under the monitoring and control of information in a terminal of an internal network, information may be prevented from leaking through the social network service (SNS).

According to another embodiment of the present disclosure, since encrypted information is exchanged between a terminal of an internal network and an information security device, security is improved even when there is an unauthorized approach to the internal network.

### BRIEF DESCRIPTION OF THE DRAWINGS

The above and other features and advantages of the present disclosure will become more apparent to those of ordinary skill in the art by describing in detail embodiments with reference to the attached drawings in which:

FIG. 1 is a block diagram of an information security device, a terminal and a network system including the information security device and the terminal connected to an SNS server according to an embodiment of the present disclosure;

FIG. 2 is a flowchart of an information security method according to an embodiment where information is being transmitted from the terminal to the SNS server of FIG. 1;

FIG. 3 is a flowchart of an information security method according to an embodiment where information is being transmitted from the SNS server to the terminal of FIG. 1;

FIG. 4 is a block diagram of an information security device, a terminal, and a network system including the information security device and the terminal connected to an SNS server according to another embodiment of the present disclosure;

FIG. 5 is a flowchart of an information security method according to an embodiment where information is being transmitted from the terminal to the SNS server of FIG. 4; and

FIG. 6 is a flowchart of an information security method according an embodiment where information is being transmitted from the SNS server to the terminal of FIG. 4.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

An information security device according to an embodiment of the present disclosure is a device capable of, in the case of using a service that allows a posting of an individual to be shared by unspecified 3^{rd} parties or a message to be transmitted and received to and from another person, monitoring information being exchanged between a service and a terminal to block information determined as information for which security is necessary under a predetermined condition.

A terminal according to an embodiment of the present disclosure is an information input/output device configured to exchange information with a server that provides a social network service (SNS) such that a user of the terminal may be provided with the social network service, but that the terminal is connected to the server providing the social network service (SNS) through the information security device in order to block information for which security is necessary.

A network system according to an embodiment of the present disclosure is a system where the information security device and the terminal are connected through a network, and the information security device is connected to the server that provides the social network service through a firewall. Herein, the terminal, information security device and the firewall may be connected through an internal network, and the firewall and the server that provides the social network service (SNS) may be connected through an external network, i.e. the internet.

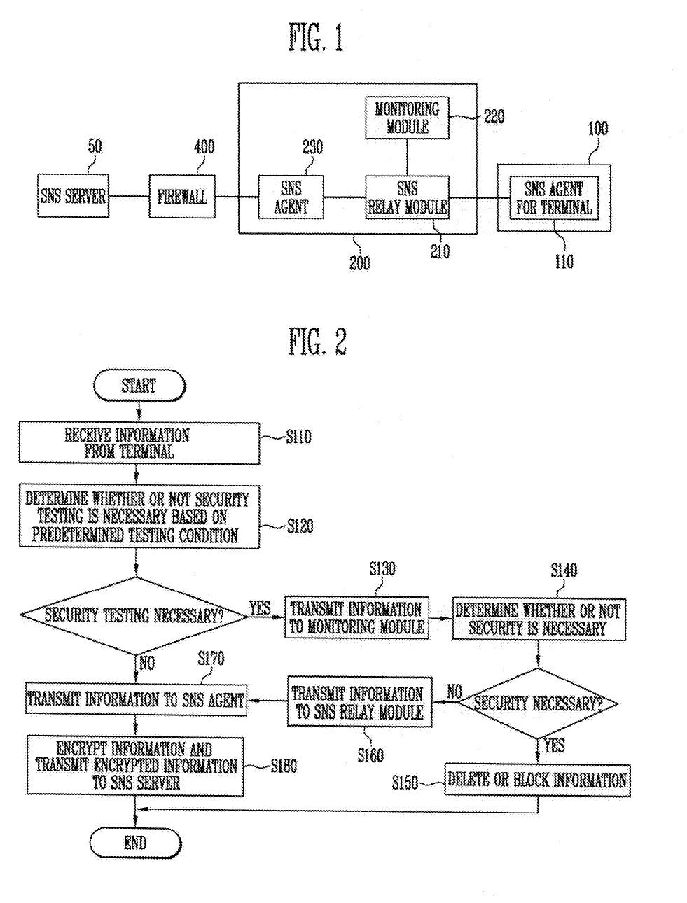

Referring to FIG. 1, an information security device according to an embodiment of the present disclosure, a terminal according to an embodiment of the present disclosure, and a network system according to an embodiment of the present disclosure will be explained in detail.

A network system according to an embodiment of the present disclosure includes a terminal 100, an information security device 200, and a firewall 400. The terminal 100 and the information security device 200 are connected to the server (50, hereinafter referred to as SNS server) that provides a social network service (SNS), through the firewall 400.

The information security device 200 according to an embodiment includes an SNS relay module 210, a monitoring module 220 that exchanges information with the SNS relay module 210 and that determines whether or not information received needs security, and an SNS agent 230 that intermediates information exchange between the SNS relay module 210 and the SNS server 50.

The SNS relay module 210 receives information from the terminal 100 or the SNS server 50, and determines whether or not the received information needs security testing based on a predetermined testing condition. Security testing refers to determining whether or not information being exchanged between the terminal 100 and the SNS server 50 is information that needs to be blocked. In other words, security testing refers to testing whether or not the information being transmitted from the terminal 100 to the SNS server 50 is confidential information or whether or not the information being transmitted from the SNS server 50 to the terminal 100 is information of a malignant code or malignant link and the like that may contaminate the internal network.

Security testing is performed by the monitoring module 220, and the SNS relay module 210 determines whether or not security testing is necessary and transmits information determined as information that needs security testing to the monitoring module 220.

A predetermined testing condition may include a condition of determining whether or not security testing is necessary depending on the type of the information. That is, the SNS relay module 210 may determine whether or not security testing is necessary based on the type of the information. More specifically, the SNS relay module 210 may determine whether or not security testing is necessary depending on whether or the information is a type of information that needs security testing. In this case, the type of information that needs security testing and the type of information that does not need security testing may be predetermined.

In the case the type of information received from the terminal 100 or the SNS server 50 is a type of information that does not need security testing, the SNS relay module 210 transmits the information to the SNS agent 230. The SNS agent 230 transmits the information to the firewall 400 so that the information may be transmitted to the terminal 100 or the SNS server 50.

In the case of a type of information having a possibility of including confidential information, this type of information may be predetermined as the type of information that needs security testing. For example, in the case of information such as an image, a document file, or a text, since this type of information has a possibility of including confidential information, it is predetermined as the type of information that needs security testing.

In the case of a type of information related to input or output information of the terminal 100, this type of information may be predetermined as the type of information that does not need security testing. For example, in the case of a type of information needed for displaying a social network service on the terminal 100, this type of information may be predetermined as the type of information that does not need security testing. Otherwise, for example, screen output information of an application relating to the social network service and user input information on the terminal 100 are predetermined as the type of information that does not need security testing.

The SNS relay module 210 transmits information determined as information that does not need security testing to its originally intended destination. For example, if the information received from the SNS server 50 is screen output information of the social network service, the SNS relay module 210 determines that the information does not need security testing, and transmits the information to the terminal 100. Otherwise, if the information received from the terminal 100 is user input information generated in the terminal 100, the SNS relay module 210 may determine that the information does not need security testing, and transmit the information to the SNS agent 230 so that an input by be generated according to the input information.

In the case of a type of information that may contaminate the network to which the terminal 100 is connected, this type of information may be predetermined as a type of information that needs security testing. For example, if the type of information is an executing file or a hyperlink, it may contaminate the network, and thus this type of information is predetermined as the type of information that needs security testing. The hyperlink may be hyperlink information being loaded as a corresponding input is executed in the terminal 100 by the user input information transmitted to the SNS agent 230. However, if the information is an executing file, the load of the input may be blocked by the firewall 400.

The monitoring module 220 exchanges information with the SNS relay module 210, and determines whether or not received information needs security based on a predetermined security condition. The monitoring module 220 transmits information determined as information that does not need security to the SNS relay module 210.

A predetermined security condition may include a condition of determining whether or not the information received in the monitoring module 220 needs security based on a content of the information. For example, the predetermined security condition may include a condition of determining that in the case the information is a file or a text, if the information includes a predetermined content, it needs security, in order words needs to be blocked, but if the information does not include the predetermined content, the information does not need security. The predetermined content may refer to a confidential content that must not be posted on the SNS. Otherwise, the predetermined security condition may include a condition of determining that in the case the information is a hyperlink, if the information includes a predetermined hyperlink or a predetermined text, it needs security.

The monitoring module 220 deletes information determined as information that needs security instead of transmitting the information to the SNS relay module 210. For example, if the information determined as information that needs security is a file or a text, the monitoring module 220 deletes it. Otherwise, if the information determined as information that needs security is a file or a message including a hyperlink, the monitoring module 200 may determine whether or not a website corresponding to the hyperlink is a malicious site and block the traffic corresponding to the hyperlink or delete the file or the message according to the determination.

In another embodiment, the information security device 200 may further include a memory (not illustrated). In this case, the information determined in the monitoring module 220 as information that needs security may be stored in the memory. When the information determined as information that needs security is stored in the memory, packets being transmitted between the SNS server 50 and the terminal may be tracked and analyzed even when the information is not left in the monitoring module 220. Furthermore, in another embodiment, the monitoring module 220 may analyze the traffic content corresponding to the information, and block the traffic of a corresponding terminal 100 or transmit a warning message to the corresponding terminal 100.

The SNS relay module 210 transmits information determined as information that does not need security testing or information determined by the monitoring module 220 as information that does not need security to the SNS agent 230.

The SNS agent 230 intermediates information exchange between the SNS relay module 210 and the SNS server 50. The SNS agent 230 encrypts information being transmitted to the SNS server 50 and decrypts information encrypted by and being transmitted from the SNS server 50. The SNS relay module 210 is connected to the SNS server 50 through the firewall 400. Such an SNS agent 230 may perform communication with the SNS server 50 in the same manner as an agent (for example an application installed in a tablet or mobile phone and the like) of a well known social network service. That is, the SNS agent 230 may be a well known software or hardware developed for using the social network service.

In another embodiment, the information security device 200 may further include a memory that stores the predetermined security condition or the predetermined testing condition.

A terminal 100 according to an embodiment includes an SNS agent for terminal 110. For example, the terminal 100 may be any device such as a laptop computer, tablet, and mobile phone and the like capable of providing a social network service (SNS) including displaying and inputting/outputting information of the social network service. In various embodiments, the terminal 100 may be configured to further include a device for inputting, processing, and outputting information. Such a device for inputting, processing and outputting (including displaying) information may be a well known device, and thus detailed explanation is omitted.

The SNS agent for terminal 110 is configured to exchange information with the SNS relay module 210 and to provide the social network service through the information security device 200. The SNS agent for terminal 110 may be any software and/or hardware configured to exchange information with the SNS relay module 210 and to allow a social network service to be provided in the terminal 100.

The firewall 400 transmits information received from the SNS agent 230 to the SNS server 50, and transmits information received from the SNS server 50 to the SNS agent 230.

In another embodiment, the firewall 400 may determine whether or not the terminal 100 intending to exchange information with the SNS server 50 has authority to access the corresponding SNS server, and may allow information exchange only when the terminal 100 has the authority. That is, even information received from the information security device 200 may be blocked from being transmitted to the SNS server 50 by the firewall 400.

For example, the firewall 400 may identify a name of the SNS and the terminal 100 based on information on an IP header of the terminal 100, and if it is determined that the terminal 100 does not have authority to access the SNS server, the firewall 400 may block information exchange between the SNS server 50 and the terminal 100. Such a firewall 400 may be configured the same as a well known next generation firewall.

FIG. 1 illustrates only one terminal 100, but in another embodiment, a network system according to the present disclosure may include a plurality of terminals 100. In the case where a plurality of terminals are provided, the plurality of terminals may all have a same level of authority of using a social network service, or each terminal may have a different level of authority of using the social network service. For example, a first terminal may be predetermined such that it may access a server that provides a social network service, while a second terminal is predetermined such that it may not access the server that provides the social network service.

Hereinafter, a method for selectively transmitting information between the SNS server 50 and the terminal 100 by the information security device 200, terminal 100 and network system according to an embodiment of the present disclosure will be explained in detail.

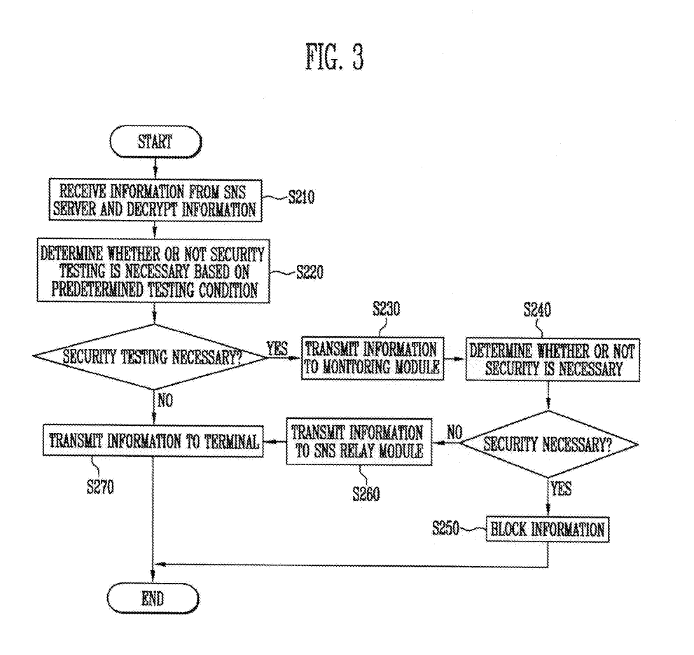

FIG. 2 is a flowchart illustrating an information security method in an information security device 200 in the case where information is being transmitted from the terminal 100 to the SNS server 50. The information security method according to an embodiment includes a step of receiving information (S110), a step of determining whether or not security testing is necessary (S120), a step of determining whether or not security is necessary (S130, S140), and a step of selectively transmitting information (S150, S160, S170, S180).

At the step of receiving information (S110), information input into the terminal 100 is transmitted to the SNS relay module 210 through the SNS agent for terminal 110. At the step of determining whether or not security testing is necessary (S120), the SNS relay module 210 determines whether or not information received from the SNS agent for terminal 110 needs security testing based on a predetermined testing condition.

For example, in the case where the information received from the SNS agent for terminal 110 is a file or a text, it is determined by the SNS relay module 210 that security testing is necessary. Otherwise, in the case where the information received from the SNS agent for terminal 110 is user input information, it is determined by the SNS relay module 210 that security testing is not necessary.

The step of determining whether or not security is necessary (S130, S140) includes a step of transmitting the information determined as information that needs security testing to the monitoring module 220 (S130), and a step of determining whether or not security is necessary (S140).

At the step of transmitting the information determined as information that needs security testing to the monitoring module 220, the information determined by the SNS relay module 210 as information that needs security testing is transmitted to the monitoring module 220. For example, in the case where the information received from the SNS agent for terminal 110 is a file or a text, the SNS agent for terminal 110 transmits the file or the text to the monitoring module 220.

At the step of determining whether or not security is necessary (S140), the monitoring module 220 determines whether or not the received information needs security based on the predetermined security condition.

For example, in the case where the content of the file or the text includes a predetermined content, the monitoring module 220 determines that the information needs security. On the other hand, in the case where the content of the file or the text does not include the predetermined content, the monitoring module 220 determines that the information does not need security.

The step of selectively transmitting information (S150, S160, S170, S180) includes a step of blocking information (S150), and a step of transmitting information (S160, S170, S180).

At the step of blocking information (S150), the monitoring module 220 deletes the information determined as information that needs security.

In the case of information determined as information that does not need security testing (for example, user input information) or information determined as information that does not need security (for example a text or file that does not include the predetermined content), at the step of transmitting information (S160, S170, S180), this information is transmitted to the SNS server 50. The step of transmitting information includes a step of transmitting information to the SNS relay module 210 by the monitoring module 220 (S160), a step of transmitting information to the SNS agent 230 by the SNS relay module 210 (S170), and a step of transmitting information to the SNS server 50 by the SNS agent 230 (S180).

At the step of transmitting information to the SNS relay module 210 (S160), information determined by the monitoring module 220 as information that does not need security is transmitted to the SNS relay module 210. At the step of transmitting information to the SNS agent 230 (S170), information determined by the SNS relay module 210 as information that does not need security testing and information received from the monitoring module 220 to the SNS relay module 210 is transmitted to the SNS agent 230.

At the step of transmitting information to the SNS server 50 (S180), the received information is encrypted by the SNS agent 230 and is then transmitted to the SNS server 50 through the firewall 400. However, in another embodiment, information transmission may be further blocked in the firewall 400, as mentioned earlier on.

FIG. 3 is a flowchart illustrating an information security method in an information security device 200 in the case where information is being transmitted from the SNS server 50 to the terminal 100. The information security method according to an embodiment includes a step of receiving information (S210), a step of determining whether or not security testing is necessary (S220), a step of determining whether or not security is necessary (S230, S240), and a step of selectively transmitting information (S250, S260, S270).

At the step of receiving information (S210), information transmitted from the SNS server 50 is received in the SNS agent 230 through the firewall 400, and the corresponding information is transmitted to the SNS relay module 210 by the SNS agent 230. Herein, the information transmitted from the SNS server 50 is decrypted by the SNS agent 230 and then transmitted to the SNS relay module 210.

At the step of determining whether or not security testing is necessary (S220), the SNS relay module 210 determines whether or not information received from the SNS server 50 needs security testing based on a predetermined testing condition.

For example, in the case where the information received from the SNS server 50 is screen output information of a social network service, the SNS relay module 210 determines that the information does not need security testing. In the case where the information received from the SNS server 50 is a hyperlink that occurred by a user input in the terminal 100, the SNS relay module 210 determines that the information needs security testing.

The step of determining whether or not security is necessary (S230, S240) includes a step of transmitting information determined by the SNS relay module 210 as information that needs security testing to the monitoring module 220 (S230), and a step of determining by the monitoring module 220 that security is necessary based on a predetermined security condition (S240).

At the step of transmitting information determined as information that needs security testing to the monitoring module 220 (S230), the information determined by the SNS relay module 210 as information that needs security testing is transmitted to the monitoring module 220.

For example, in the case where the information received from the SNS server 50 is a hyperlink, the hyperlink is transmitted to the monitoring module 220.

At the step of determining by the monitoring module 220 that security is necessary (S240), the monitoring module 220 determines whether or not the received information needs security based on the predetermined security condition.

For example, in the case where the hyperlink corresponds to the predetermined hyperlink or includes a predetermined text, the monitoring module 220 determines that the information needs security. On the other hand, if the hyperlink does not correspond to the predetermined hyperlink or does not include the predetermined text, the monitoring module 220 determines that the information does not need security.

The step of selectively transmitting information (S250, S260, S270) includes a step of blocking information (S250), and a step of transmitting information (S260, S270).

At the step of blocking information (S250), the monitoring module 220 blocks information determined as information that needs security.

At the step of transmitting information (S260, S270), information determined as information that does not need security testing (for example, screen output information) and information determined as information that does not need security (for example, that does not correspond to the predetermined hyperlink or does not include the predetermined text) are transmitted to the terminal 100. The step of transmitting information includes a step of transmitting information to the SNS relay module 210 by the monitoring module 220 (S260), and a step of transmitting information to the terminal 100 by the SNS relay module 210 (S270).

At the step of transmitting information to the SNS relay module 210 (S260), information determined by the monitoring module 220 as information that does not need security is transmitted to the SNS relay module 210. At the step of transmitting information to the terminal 100 (S270), information determined by the SNS relay module 210 as information that does not need security testing and information received from the monitoring module 220 to the SNS relay module 210 is transmitted to the SNS agent for terminal 110.

Referring to FIG. 2 and FIG. 3, the aforementioned steps may be proceeded at the same time or one step may be proceeded prior to another step.

An information security device according to another embodiment of the present disclosure is a device capable of, in the case of using a social network service (SNS), for example facebook, twitter, and kakaotalk to share a posting of an individual with unspecified 3^{rd} parties and to transmit and receive messages to and from another person, monitoring information being exchanged between the service and a terminal to block information determined as information that needs security according to a predetermined condition. Furthermore, an information security device according to another embodiment of the present disclosure is a device capable of encrypting and decrypting information between exchanged between the service and a terminal, and of storing blocked information to track and analyze the blocked information later on.

A terminal according to another embodiment of the present disclosure is an input/output device connected to a server providing a social network service in order to exchange information with the server so that a user of the terminal may be provided with the social network service, but that is connected to the server through an information security device such that of the information being input into the terminal, information that needs security may be blocked. Furthermore, a terminal according to another embodiment of the present disclosure is a device configured to transmit and receive encrypted information to and from the information security device to maintain security in an internal network as well.

A network system according to another embodiment of the present disclosure is a system where an information security device and terminal are connected through a network, and the information security device is connected to a server providing the social network service, through a firewall. Herein, the terminal, the information security device and the firewall may be connected through an internal network, and the firewall and the server providing the social network service may be connected through an external network, that is the internet. The network system according to an embodiment has increased security since information being exchanged between the information security device and the terminal is encrypted, and information being exchanged between the information security device and the SNS server is encrypted.

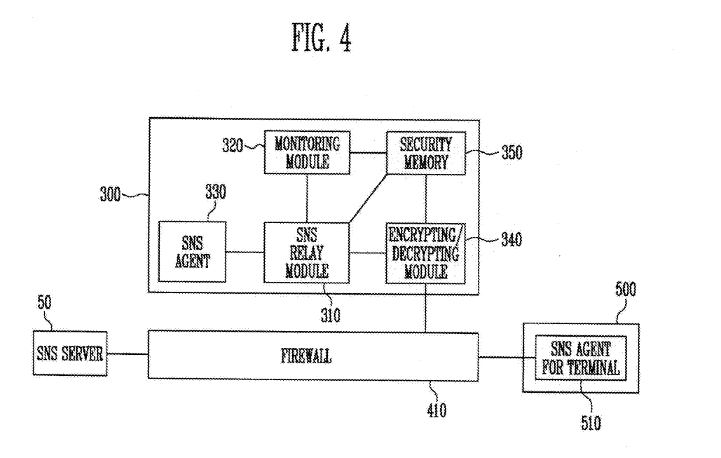

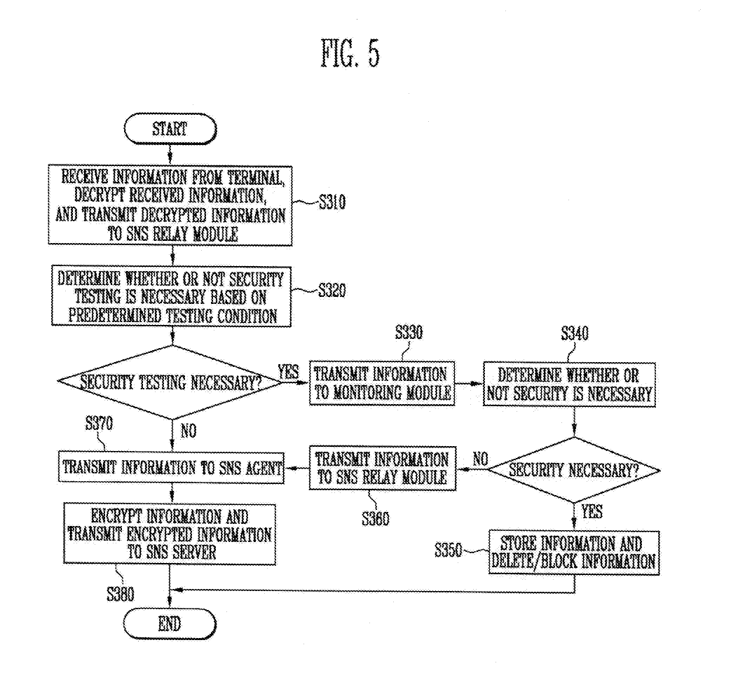

FIG. 4 is a block diagram illustrating an information security device, a terminal, and a network system according to another embodiment of the present disclosure. Referring to FIG. 4, other embodiments of the present disclosure will be explained in detail.

A network system according to an embodiment of the present disclosure includes the terminal 500, the information security device 300 and the firewall 410. The terminal 500 is connected with the information security device 300 through the firewall 410. Furthermore, the information security device 300 is connected with the SNS server 50, through the firewall 410.

Therefore, the network system according to an embodiment of the present disclosure has improved security since the connection between the terminal 500 and the information security device 300 is encrypted and the connection between the information security device 300 and the SNS server 50 is encrypted.

An information security device 300 according to an embodiment includes an SNS relay module 310, a monitoring module 320, a SNS agent 330, an encrypting/decrypting module 340 and a security memory 350 The terminal 500 according to another embodiment includes an SNS agent for terminal 210. In various embodiments, the terminal 500 may further include a device necessary for inputting, processing and outputting information.

The SNS agent for terminal 510 is configured such that a social network service may be provided through the information security device 300. Furthermore, the SNS agent for terminal 510 encrypts information to be transmitted to the information security device 300, and decrypts information received from the information security device 300.

The SNS agent for terminal 510 may be any software and/or hardware configured such that encrypted information may be exchanged with the encrypting/decrypting module 340 through the firewall 410 and that a social network service may be provided through the terminal 500.

The terminal 500 may be any device such as a desktop computer, laptop computer, tablet, mobile phone and the like configured to provide a social network service including displaying the social network service and inputting/outputting information. The device necessary for inputting, processing and outputting (including displaying) information may be a well known device, and thus detailed explanation is omitted.

The encrypting/decrypting module 340 decrypts information received from the SNS agent for terminal 510 and transmits the decrypted information to the SNS relay module 310, and encrypts information received from the SNS relay module 310 and transmits the encrypted information to the SNS agent for terminal 510. The encrypting/decrypting module 340 may be any well known software or hardware capable of encrypting and decrypting information being transmitted through a network.

The information that the encrypting/decrypting module 340 receives is information being exchanged between the terminal 500 and the SNS server 50. Examples of information that the encrypting/decrypting module 340 receives include user input information that occurred in the terminal 500, information on a file or a text, screen output information of a social network service received from the SNS server 50, and hyperlink information.

The SNS relay module 310 receives information from the terminal 500 or the SNS server 50. More specifically, the SNS relay module 310 receives information decrypted in the encrypting/decrypting module 340 or information decrypted in the SNS agent 330. The SNS relay module 310 determines whether or not the received information needs security testing based on a predetermined testing condition.

Security testing refers to determining whether or not information being exchanged between the terminal 500 and the SNS server 50 is information that needs to be blocked. Security testing is the same as that explained with reference to FIGS. 1 to 3, and thus detailed explanation is omitted.

Security testing is performed by the monitoring module 230, and the SNS relay module 310 determines whether or not security testing is necessary, and transmits information determined as information that needs security testing to the monitoring module 320.

The predetermined testing condition may include a condition of determining whether or not information needs security testing based on the type of the information. The predetermined testing condition and the type of the information are the same as the predetermined testing condition and the type of the information explained with reference to FIGS. 1 to 3, and thus detailed explanation is omitted.

The SNS relay module 310 transmits information determined as information that does not need security testing to an originally intended destination. For example, when the SNS relay module 310 determines that the information (for example, user input information) received from the encrypting/decrypting module 230 is information that does not need security testing, the SNS relay module 310 transmits the information to the SNS server 50 through the SNS agent 330. Furthermore, when the SNS relay module 310 determines that the information (for example screen output information on a social network service) received from the SNS agent 330 is information that does not need security testing, the SNS relay module 310 transmits the information to the terminal 500 through the encrypting/decrypting module 340.

Furthermore, the SNS relay module 310 transmits the information determined by the monitoring module 320 as information that does not need security to its originally intended destination. This will be explained in more detail hereinafter.

The monitoring module 320 exchanges information with the SNS relay module 310, and determines whether or not the received information is information that needs security based on a predetermined security condition, and transmits the information determined as information that does not need security to the SNS relay module 310.

The predetermined security condition may include a condition of determining whether or not information needs security based on a content of the information received in the monitoring module 320. The predetermined security condition and the content of the information are the same as the security condition and the content of the information explained with reference to FIGS. 1 to 3, and thus detailed explanation is omitted.

The monitoring module 320 transmits information determined as information that needs security to the security memory 350 to store the information instead of transmitting the information to the SNS relay module 310. For example, in the case where the information determined as information that needs security is a file or text, the monitoring module 320 stores the information in the security memory 350 but deletes the information from the monitoring module 320. Otherwise, if the information determined as information that needs security is a hyperlink, the monitoring module 320 stores the traffic in the security memory 350, and blocks the traffic.

Once the information determined as information that needs security is stored in the security memory 350, packets being transmitted between the SNS server 50 and the terminal may be tracked and analyzed later on even if the information is not left in the monitoring module 320. Furthermore, in another embodiment, the monitoring module 230 may analyze the traffic content of the information, and block the traffic of the terminal or transmit a warning message to the terminal 500.

The monitoring module 320 transmits information determined as information that does not need security to the SNS relay module 310. The SNS relay module 310 transmits the information received from the monitoring module 320 to its originally intended destination. For example, in the case where the information determined as information that does not need security is a file or text received from the terminal 500, the SNS relay module 310 transmits the information to the SNS server 50 through the SNS agent 330. In the case where the information determined as information that does not need security is a hyperlink received from the SNS server 50, the SNS relay module 310 transmits the information to the SNS agent for terminal 510 through the encrypting/decrypting module 340.

The SNS agent 330 intermediates information exchange between the SNS relay module 310 and the SNS server 50. The SNS agent 330 decrypts the information encrypted and received from the SNS server 50 and transmits the decrypted information to the SNS relay module 310. The SNS agent 330 encrypts the information received from the SNS relay module 310 and transmits the encrypted information to the SNS server 50. Herein, information exchange between the SNS agent 330 and the SNS server 50 is made through the firewall 410.

Such an SNS agent 330 is the same as the SNS agent 230 of FIG. 1, and thus detailed explanation is omitted.

The security memory 350 stores data related to the testing condition and data related to the security condition. Furthermore, in the security memory 350, information determined by the monitoring module 320 as information that needs security is stored. Therefore, even if the information is deleted by the monitoring module 230, it is still possible to track and analyze the content and traffic of the information that had been deleted and thus blocked. Besides the above, when necessary, the security memory 350 may further store data that occurs as information is processed in the SNS relay module 310 and the monitoring module 320, and the information.

The firewall 410 may transmit information received from the SNS agent 330 to the SNS server 50, and transmit information received from the SNS server 50 to the SNS agent 330. Furthermore, the firewall 410 may transmit information received from the SNS agent for terminal 510 to the encrypting/decrypting module 340, and transmit information received from the encrypting/decrypting module 340 to the SNS agent for terminal 510.

In another embodiment, the firewall 410 may determine whether or not a terminal 500 intending to exchange information with the SNS server 50 has authority to access the SNS server 50, and allow information exchange only when the SNS server 50 has the authority. That is, even information received from the information security device 300 may be blocked from being transmitted to the SNS server 50 by the firewall 410. That is the same as in the firewall 400 of the embodiment of FIG. 1, and thus detailed explanation is omitted.

FIG. 4 illustrates only one terminal 500, but in another embodiment, the network system according to the present disclosure may be provided with a plurality of terminals 500. The case where a plurality of terminals is provided is the same as the case in the embodiment of FIG. 1, and thus detailed explanation is omitted.

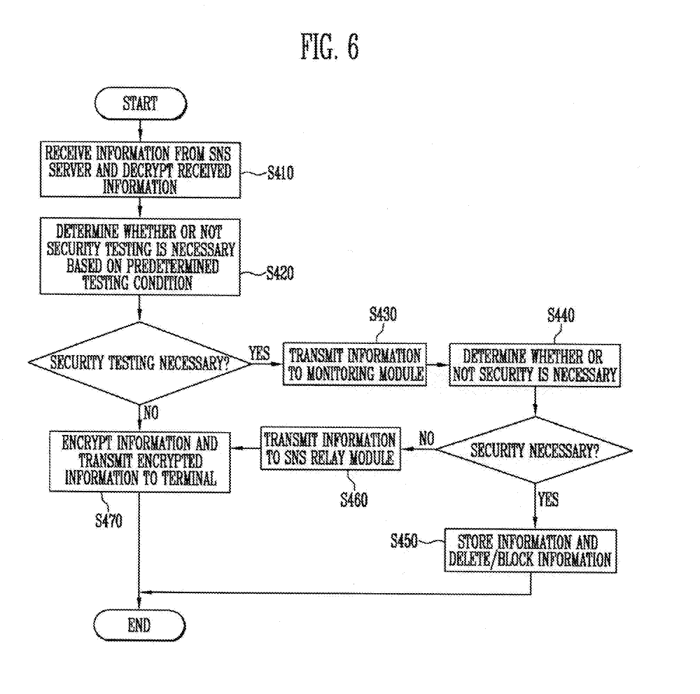

Hereinafter, a method for selectively transmitting information between the SNS server 50 and the terminal 500 by an information security device, terminal and network system according to another embodiment of the present disclosure will be explained in detail with reference to FIGS. 5 and 6.

FIG. 5 is a flowchart illustrating an information security method in an information security device 300 in the case where information is being transmitted from the terminal 500 to the SNS server 50. The information security method according to an embodiment includes a step of receiving information (S310), a step of determining whether or not security testing is necessary (S320), a step of determining whether or not security is necessary (S330, S140), and a step of selectively transmitting information (S350, S360, S370, S380).

At the step of receiving information (S310), information input into the terminal 500 is received and a password received is decrypted and transmitted to the SNS relay module 310. More specifically, encrypted information is transmitted from the SNS agent 510 to the encrypting/decrypting module 340 through the firewall 410. The encrypted information is decrypted by the encrypting/decrypting module 340, and then transmitted to the SNS relay module 310.

At the step of determining whether or not security testing is necessary (S320), the SNS relay module 310 determines whether or not the information decrypted by the encrypting/decrypting module 340 needs security testing based on a predetermined testing condition.

For example, in the case where the information received from the SNS agent for terminal 510 is a file or text, the SNS relay module 310 determines that the information needs security testing. In the case where the information received from the SNS agent for terminal 510 is user input information, it is determined by the SNS relay module 310 that security testing is not necessary.

The step of determining whether or not security is necessary (S330, S340) includes a step of transmitting the information determined by the SNS relay module 310 as information that needs security testing to the monitoring module 320 (S330), and a step of determining whether or not security is necessary (S340).

At the step of transmitting the information determined as information that needs security testing to the monitoring module 320 (S330), the information determined by the SNS relay module 310 as information that needs security testing is transmitted to the monitoring module 320.

For example, in the case where the received information is a file or a text, the SNS agent for terminal 110 transmits the file or the text to the monitoring module 220.

At the step of determining whether or not security is necessary (S340), the monitoring module 220 determines whether or not the information received needs security based on the predetermined security condition.

For example, in the case where the file or the text includes the predetermined content, the monitoring module 320 determines that the information needs security. On the other hand, in the case where the file or the text does not include the predetermined content, the monitoring module 320 determines that the information does not need security.

The step of selectively transmitting information (S350, S360, S370, S380) includes a step of blocking and storing information (S350), and a step of transmitting information (S360, S370, S380).

At the step of blocking and storing information (S350), the file or text that includes the predetermined content, i.e. information that needs security, is stored in the security memory 350, and then deleted from the monitoring module 320.

At the step of transmitting information (S360, S370, S380), in the case of information determined as information that does not need security testing (for example, user input information) or information determined as information that does not need security (for example, a file or text that does not include the predetermined content), the information is transmitted to the SNS server 50 through the firewall 410. The step of transmitting information includes a step of transmitting information to the SNS relay module 310 by the monitoring module 320 (S360), a step of transmitting information to the SNS agent 330 by the SNS relay module 310 (S370), and a step of transmitting information to the SNS server 50 by the SNS agent 330 (S380).

At the step of transmitting information to the SNS relay module 310 (S360), information determined by the monitoring module 320 as information that does not need security is transmitted to the SNS relay module 310. At the step of transmitting information to the SNS agent 330 (S370), information determined by the SNS relay module 310 as information that does not need security testing and information received from the monitoring module 320 to the SNS relay module 310 are transmitted to the SNS agent 330.

At the step of transmitting information to the SNS server 50 (S380), the information received is encrypted by the SNS agent 330 and then transmitted to the SNS server 50 through the firewall 410. However, in another embodiment, information transmission may be further blocked in the firewall 410, as mentioned earlier on.

FIG. 6 is a flowchart illustrating an information security method in an information security device 300 in the case where information is being transmitted from the SNS server 50 to the terminal 500. An information security method according to an embodiment includes a step of receiving information (S410), a step of determining whether or not security testing is necessary (S420), a step of determining whether or not security is necessary (S430, S440), and a step of selectively transmitting information (S450, S460, S470, S480).

At the step of receiving information (S410), information transmitted from the SNS server 50 is transmitted to the SNS agent 330 through the firewall 410, and the information is transmitted from the SNS agent 330 to the SNS relay module 310. Herein, the information transmitted from the SNS server 50 is decrypted by the SNS agent 330 and then transmitted to the SNS relay module 310.

At the step of determining whether or not security testing is necessary (S420), the SNS relay module 310 determines whether or not the information received from the SNS server 50 needs security testing based on a predetermined testing condition.

For example, in the case where the information received from the SNS server 50 is screen output information of a social network service, the SNS relay module 310 determines that the information does not need security testing. In the case where the information received from the SNS server 50 is a hyperlink occurred by a user input, the SNS relay module 310 determines that the information needs security testing.

Steps of determining whether or not security is necessary (S430, S440) include a step where the SNS relay module 310 transmits the information determined by the SNS relay module 310 as information that needs security testing to the monitoring module 320 (S430), and a step of determining that the information needs security (S440).

At the step of transmitting the information determined as information that needs security testing to the monitoring module 320 (S430), the information determined by the SNS relay module 310 as information that needs security testing is transmitted to the monitoring module 320.

The step of determining whether or not security is necessary (S430, S440) includes a step of transmitting by the SNS relay module 310 the information determined by the SNS relay module 310 as information that needs security testing to the monitoring module 320 (S430), and a step of determining whether or not security is necessary (S440).

For example, in the case where the information received from the SNS server 50 is a hyperlink, the hyperlink is transmitted to the monitoring module 320.

At the step of determining whether or not security is necessary (S440), the monitoring module 320 determines whether or not the received information needs security based on the predetermined security condition.

For example, in the case where the hyperlink corresponds to a predetermined hyperlink or includes a predetermined text, the monitoring module 320 determines that the information needs security. On the other hand, in the case where the hyperlink does not correspond to the predetermined hyperlink or does not include the predetermined text, the monitoring module 320 determines that the information does not need security.

Steps of selectively transmitting information (S450, S460, S470) includes a step of storing and blocking information (S450), and steps of transmitting information (S460, S470).

At the step of storing and blocking information (S450), the monitoring module 320 blocks the hyperlink determined as information that needs security and stores the hyperlink in the security memory 350.

At the step of transmitting information (S460, S470), information determined as information that does not need security testing (for example screen output information) or information determined as information that does not need security (for example hyperlink that does not correspond to the predetermined hyperlink or that does not include the predetermined text) is transmitted to the terminal 500. The step of transmitting information includes a step of transmitting information to the SNS relay module 310 by the monitoring module 320 (S460) and a step of transmitting information to the terminal 500 by the SNS relay module 310 (S470).

At the step of transmitting information to the SNS relay module (S460), the information determined by the monitoring module 320 as information that does not need security is transmitted to the SNS relay module 310. At the step of transmitting information to the terminal (S470), the information determined by the SNS relay module as information that does not need security testing and the information received from the monitoring module to the SNS relay module are encrypted by the encrypting/decrypting module 340, and then transmitted to the SNS agent for terminal 510.

Each step aforementioned with reference to FIGS. 5 and 6 may be proceeded at the same time or a step may be proceeded prior to another step unlike the illustration.

According to various embodiments of the present disclosure, there is an effect of selectively blocking information exchange with a social network service according to necessity of security while being provided with the social network service through a terminal of an internal network.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. An information security device comprising:
an SNS relay module configured to receive information from any one of a server that provides a social network service (hereinafter SNS) and a terminal, and determine whether or not the information needs security testing based on a predetermined testing condition;
a monitoring module configured to determine whether or not information, that is determined as information that needs security testing, needs security based on a predetermined security condition; and
an SNS agent module configured to transmit information determined as information that does not need security testing or information determined as information that does not need security outside.

2. The device according to claim 1,
wherein the predetermined testing condition comprises a condition of determining whether or not the information needs security testing based on a type of the information.

3. The device according to claim 2,
wherein the predetermined testing condition comprises:
a condition of determining that the information needs security testing when the type of the information is an image file, a document file, a text, an execution file or a hyperlink.

4. The device according to claim 2,
wherein the predetermined security condition comprises a condition of determining that the information does not need security testing when the type of the information is a type of information related to input or output information of the terminal.

5. The device according to claim 1,
wherein the predetermined security condition comprises a condition of determining whether or not the information needs security based on a content of the information.

6. The device according to claim 5,
wherein the predetermined security condition comprises a condition of determining that the information needs security when the content of the information comprises a predetermined text.

7. The device according to claim 6,
wherein the monitoring module deletes the information when the content of the information comprises the predetermined text.

8. The device according to claim 6,
further comprising a memory for storing the information so that it is used in track analysis of packets transmitted between the server and the terminal when the content of the information comprises the predetermined text.

9. The device according to claim 6,
wherein the monitoring module determines, when the information is a file or a message including hyperlink, whether or not a website corresponding to the hyperlink is a malicious site, and deletes the file or the message based on the determination.

10. The device according to claim 6,
wherein the monitoring module determines, when the information is a file or a message including hyperlink, whether or not a website corresponding to the hyperlink is a malicious site, and performs track analysis of the website.

11. The device according to claim 1,
further comprising an encrypting/decrypting module configured to decrypt the information being received from any one of the server and the terminal, and to encrypt the information being transmitted outside.

12. The device according to claim 1,
wherein the SNS relay module is configured to receive the information from an SNS agent that is provided in the terminal and allows the SNS to be provided to the terminal through the information security device.

13. An information security method, the method comprising:
determining, when information is received from any one of a server that provides a social network service (hereinafter SNS) and a terminal, whether or not the information needs security testing based on a predetermined testing condition;
determining whether or not information, that is determined as information that needs security testing, needs security based on a predetermined security condition; and
transmitting information determined as information that does not need security testing or information determined as information that does not need security to outside.

14. The method according to claim 13,
wherein the predetermined testing condition comprises:
a condition of determining that the information needs security testing when the type of the information is an image file, a document file, a text, an execution file or a hyperlink.

15. The method according to claim 13,
wherein the predetermined testing condition comprises a condition of determining that the information does not need security testing when the type of the information is a type of information related to input or output information of the terminal.

16. The method according to claim 13,
wherein the predetermined security condition comprises a condition of determining that the information needs security when the content of the information comprises a predetermined text.

17. The method according to claim 16,
further comprising deleting the information when the content of the information comprises the predetermined text.

18. The method according to claim 16,
further comprising storing the information when the content of the information comprises the predetermined text so that the information is used in track analysis of packets transmitted between the server and the terminal.

19. The method according to claim 13,
further comprising:
receiving the information from any one of the server and the terminal; and
decrypting the information.

20. The method according to claim 13,
wherein the transmitting information determined as information that does not need security testing or that does not need security to outside comprises encrypting the information being transmitted outside.
